(19) United States
(12) Patent Application Publication
(10) Pub. No.: US 2004/0187032 A1
(43) Pub. Date: Sep. 23, 2004

(54) Method, data carrier, computer system and computer progamme for the identification and defence of attacks in server of network service providers and operators

(76) Inventors: Christoph Gels, Lorsch (DE); Eberhard Pausch, Wettenberg (DE); Thomas Soysal, Walldorf (DE); Ralf Schlemann, Muhlhausen (DE)

Correspondence Address: Robert W Becker & Associates, Suite B, 707 Highway 66 East, Tijeras, NM, 87059, US

(21) Appl. No.: 10/486,812

(22) PCT Filed: Aug. 13, 2001
(86) PCT No.: PCT/EP01/09328

(51) Int. Cl. G06F 11/30; G06F 15/173

(52) U.S. Cl. 713/201; 709/224

(57) ABSTRACT

The invention relates to a method for the identification and defence of attacks on the server systems of network service providers and operators, using an electronic device (4) that can be integrated into a computer network and that comprises a computer programme, and relates to a data carrier, which contains a computer programme for carrying out said method. The invention also relates to a computer system, which is connected to a network, such as the Internet (6), an intranet or similar and has one or several computers that are configured as server computers (2) or client computers, and to a computer programme containing computer programme codes for the identification and defence of attacks on server systems. The invention comprises —protection against DoS and DDoS attacks (flood attacks)—link-level security, —verification of valid IP headers, —verification of IP packet characteristics, —TCP/IP fingerprint protection, —blocking of all UDP network packets, —exclusion of specific external IP addresses, —packet-level firewall function, —protection of accessible services of the target system. The invention provides the highest possible degree of security and protection against DoS and DDoS attacks.

The invention relates to a method for the recognition of and defense against attacks on server systems of network service providers and carriers by an electronic device that has to be integrated into a computer network and contains a computer software and to a data medium containing a computer software which performs this technique. Furthermore the invention relates to a computer system which is connected to a network like Internet, intranet and the like, containing one or more computers which are configured as server computers or client computers and to a computer software product containing computer software codes for the recognition of and defense against attacks on server systems of network service providers and carriers by an electronic device that has to be integrated into a computer network and contains this computer software.

The worldwide networking grows with high speed. An ever-growing number of companies increasingly trusts in the apparently unlimited possibilities in the fields of online marketing and e-Business. But also increasing are the dangers for the servers of well-known companies and institutions being blocked by attacks from the Internet.

The significance of the Internet as electronic marketplace for the e-commerce activities of many companies is growing more and more. Nevertheless the threat on company networks by DoS and DDoS attacks (Denial of Service and Distributed Denial of Service=blocking access or utilization of a computer or the service process running on it) is also growing excessively. Frequently considerable financial damage is done quite easily even without actual intrusion of hackers into the secure system environment of a company but only by successfully blocking the online business (e-commerce/e-business). Many approaches mastering the solution for this problem fell far behind the expectations. One of the reasons is that so far there has been no real method of detection for this kind of attack which is principally the only chance of defense in a system environment affected by attacks. Another problem is the nature of the Internet and the almost hopeless situation of only being able to prevent the cause of such attacks if absolutely all of the worldwide network providers would establish uniform restrictive measures for stopping such hacker attacks. Among other things this is the reason for all national attempts to prevent DoS or DDoS attacks being unsuccessful or having only moderate success so far.

As is generally known the Internet is an international network of technical components e.g. switches, routers and transmission components with multiple routing etc. Therefore often it is easily possible for hackers to paralyze single servers or complete networks or network regions. Local or national measures hardly promise an effective prevention because the international network of routers, network providers and the fancied call-by-call connections makes it quite easy for the hackers to find a way for a feasible attack strategy. Even if there are no direct damages by loss or manipulation of data or unauthorized copying of data, the loss of reputation affects the company severely.

Programs which help executing such attacks are available in the world wide web (WWW) for free. They may be downloaded by hackers at any time. Most of these feared attacks take advantage of technical flaws in the data transmission protocols which are the basis of the communication in the Internet. Mostly the affected computers are stressed with such a huge number of pretended requests so that serious requests can be processed no longer. As a result the affected computer seems to be inactive to the real customer.

Exemplary some well-known measures for protecting or preventing DoS and DDoS attacks are named.

In the local environment of the network carriers and providers measures making DoS and DDoS attacks more difficult could be taken by active blocking of faked IP addresses. That is because many DoS attacks use faked IP sender addresses (IP spoofing) to prevent detection of the hacker or at least make detection difficult. By means of appropriate technical rules in the networking infrastructure of the network carriers the network providers can reduce this significantly so that faked IP packets from the own service environment are no longer passed on to the Internet. Each organization that is connected to a network provider has at its disposal a specific range of IP addresses. Each IP packet which is sent from this organization into the Internet must have a sender address from this range. If not it is almost certainly a faked address and the IP packet should not be passed on by the network carrier, i.e. a packet filtering mechanism regarding the sender addresses should be performed while passing the packets to the Internet. IP spoofing within the permitted address range of the organization is still possible but the range of possible sources is limited to the organization. In addition to this the operation of so-called “anonymous hosts” should be revised worldwide and restricted or prohibited as far as possible. But this is extremely costly concerning organization, time, law and money.

So far the servers have often very limited abilities to resist against the practiced DoS and DDoS attacks. Some systems can withstand these attacks a little longer, some systems only very shortly. But by now longer lasting attacks are virtually always successful.

Unfortunately conventionally used packet filtering solutions often don't help against DoS and DDoS attacks or they are affected so much themselves that they lose their protective effect quite soon, at least with lasting attacks. Also numerous attack detection systems are quite inferior because often they only detect the high network traffic and issue warnings which mostly lead to reactions much too late.

In case of a successful attack the possibility of quickly reacting is of substantial relevance. Only by that means it is possible to take effective measures, maybe to identify the aggressor and to return to normal service as soon as possible. In an emergency plan a practical escalation procedure must be established. Necessary data are among other things contact person, responsible person, alternative communication paths, action directives and storage place of probably needed resources and backup media.

The servers of the carriers may be misused as agents of a DoS attack. To accomplish this the attacker installs harmful software taking advantage of well-known weak points. Therefore the carriers have to configure their servers in a careful and safe manner. Network services which are not necessary should be deactivated and those which are necessary should be secured. Adequate password and access security as well as timely changes of (especially default) passwords must be assured.

Many WWW pages in the Internet by now are only usable with browser options that are questionable under security aspects because they may be misused by an attacker.

Many content providers make programs and documents available in the Internet. If an attacker succeeds in installing a Trojan Horse he can anticipate wide distribution within a short time. This tactic is tempting attackers especially with DDoS attacks because a huge amount of hosts is necessary for an efficient attack.

Hosts of end users are usually not targets of DoS attacks. On the other hand these hosts may be used by attackers to install software which later enables remotely controlled DoS attacks at arbitrary hosts.

Hosts of end users may be misused as agents for attacks. These agents can be installed on individual hosts most simply via viruses, Trojan Horses or active contents. Therefore a reliable and current virus protection as well as the switching off of active contents in the browser is absolutely required. If necessary the use of utilities for online protection of the clients (e.g. PC-firewalls) may be thought about. However often computer viruses (esp. new ones) are not detected and eliminated adequately.

Time and again new weak points which are relevant to security are discovered in operating systems and server software and are fixed by the manufacturers a little later by updates or patches. For reacting as quickly as possible it is necessary to constantly watch software manufacturers for updates. The relevant updates must be installed as quickly as possible so that the recognized weak points are fixed.

To protect a host from risks and dangers considerable know-how is necessary for implementing an efficient IT-security configuration. Therefore administrators have to be trained sufficiently and extensively.

Certainly the measures for blocking IP-spoofing are not implemented quickly world wide and uniformly by the numerous network carriers and providers, but with the other protection measures described above, quite effective success against DoS and DDoS attacks can be reached. Nevertheless it is not possible up to now to reach a satisfactory result with the recognized methods.

The purpose of the invention is to create means for the recognition of and defense against attacks on server systems of network service providers and carriers of the kind mentioned earlier. With these methods DoS and DDoS attacks can be recognized and eliminated directly so that a high degree of security and protection against DoS and DDoS attacks is attained and the computer or the computer system is kept in a stable and efficient state continuously.

In the case of the invention in question, this purpose is achieved methodically by the components and steps

defense against DoS and DDoS attacks (flood attacks) whereas

each IP SYN (IP connection request) is registered and answered with a SYN ACK for preservation of time restrictions (timeouts) defined in the IP protocol while the registered SYN packet is checked for validity and available services in the target system and

the connection to the target system is initialized and the received data packet is forwarded to the target system for further processing if the verification was successful and the expected ACK as well as a consecutively following valid data packet was received from the requesting external system in the meantime, and/or

link level security whereas the data packets which have to be checked are received directly from the OSI layer 2 (link level), and/or

examination of valid IP headers whereas the structure of each IP packet is checked for validity before it is forwarded to the target system and each invalid packet is rejected, and/or

examination of the IP packet by especially checking the length and the checksum for conformity of the values in the TCP or IP header with the structure of the IP packet and/or

TCP/IP fingerprint protection whereas the answering outgoing data traffic from the secured systems to the requesting external systems is neutralized by using default protocol identifiers, and/or

blocking of each UDP network packet for avoiding attacks at the secured systems via the network protocol UDP (user datagram protocol), by selectively registering and unblocking services required to be reached via UDP whereas for these UDP ports messages are explicitly admitted and the other UDP ports stay closed, and/or

length restrictions of ICMP packets (Internet control message protocol) whereas only ICMP messages with a predefined maximal length are identified as valid data and others are rejected, and/or

exclusion of specific external IP addresses from the communication with the target system, and/or

packet-level firewall function whereas incoming and outgoing IP packets are examined by freely definable rules and because of these rules are rejected or forwarded to the target system, and/or

protection of reachable services of the target system by exclusion of specific services and/or users and/or redirection of service requests to other servers.

Relating to the invention the purpose is also achieved by a data medium containing a computer software for the recognition of and defense against attacks on server systems of network service providers and carriers for the use in an electronic device that has to be integrated into a computer network and contains the program steps

defense against DoS and DDoS attacks (flood attacks) whereas

each IP SYN (IP connection request) is registered and answered with a SYN ACK for preservation of time restrictions (timeouts) defined in the IP protocol while the registered SYN packet is checked for validity and available services in the target system and

the connection to the target system is initialized and the received data packet is forwarded to the target system for further processing if the verification was successful and the expected ACK as well as a consecutively following valid data packet was received from the requesting external system in the meantime, and/or

link level security whereas the data packets which have to be checked are received directly from the OSI layer 2 (link level), and/or

examination of valid IP headers whereas the structure of each IP packet is checked for validity before it is forwarded to the target system and each invalid packet is rejected, and/or

examination of the IP packet by especially checking the length and the checksum for conformity of the values in the TCP or IP header with the structure of the IP packet and/or

TCP/IP fingerprint protection whereas the answering outgoing data traffic from the secured systems to the requesting external systems is neutralized by using default protocol identifiers, and/or

blocking of each UDP network packet for avoiding attacks at the secured systems via the network protocol UDP (user datagram protocol), by selectively registering and unblocking services required to be reached via UDP whereas for these UDP ports messages are explicitly admitted and the other UDP ports stay closed, and/or

length restrictions of ICMP packets (Internet control message protocol) whereas only ICMP messages with a predefined maximal length are identified as valid data and others are rejected, and/or

exclusion of specific external IP addresses from the communication with the target system, and/or

packet-level firewall function whereas incoming and outgoing IP packets are examined by freely definable rules and because of these rules are rejected or forwarded to the target system, and/or

protection of reachable services of the target system by exclusion of specific services and/or users and/or redirection of service requests to other servers.

Preferably the data medium is represented by an EPROM and is a component of an electronic device. This electronic device may be a slot device for use in a computer or a separate device box.

Alternatively the purpose is also achieved by a computer system which is connected to a network like Internet, intranet and the like, containing one or more computers which are configured as server computers or client computers. Inserted into a data line which has to be protected and which connects the network and the server or client computers is an electronic device which is provided with a data medium containing a computer software which contains the program steps

defense against DoS and DDoS attacks (flood attacks) whereas

each IP SYN (IP connection request) is registered and answered with a SYN ACK for preservation of time restrictions (timeouts) defined in the IP protocol while the registered SYN packet is checked for validity and available services in the target system and

the connection to the target system is initialized and the received data packet is forwarded to the target system for further processing if the verification was successful and the expected ACK as well as a consecutively following valid data packet was received from the requesting external system in the meantime, and/or

link level security whereas the data packets which have to be checked are received directly from the OSI layer 2 (link level), and/or

examination of valid IP headers whereas the structure of each IP packet is checked for validity before it is forwarded to the target system and each invalid packet is rejected, and/or

examination of the IP packet by especially checking the length and the checksum for conformity of the values in the TCP or IP header with the structure of the IP packet and/or

TCP/IP fingerprint protection whereas the answering outgoing data traffic from the secured systems to the requesting external systems is neutralized by using default protocol identifiers, and/or

blocking of each UDP network packet for avoiding attacks at the secured systems via the network protocol UDP (user datagram protocol), by selectively registering and unblocking services required to be reached via UDP whereas for these UDP ports messages are explicitly admitted and the other UDP ports stay closed, and/or

length restrictions of ICMP packets (Internet control message protocol) whereas only ICMP messages with a predefined maximal length are identified as valid data and others are rejected, and/or

exclusion of specific external IP addresses from the communication with the target system, and/or

packet-level firewall function whereas incoming and outgoing IP packets are examined by freely definable rules and because of these rules are rejected or forwarded to the target system, and/or

protection of reachable services of the target system by exclusion of specific services and/or users and/or redirection of service requests to other servers.

Furthermore the solution of the purpose relating to the invention is achieved by computer software product containing computer program codes for the recognition of and defense against attacks on server systems of network service providers and carriers by an electronic device that has to be integrated into a computer network and contains this computer software product. The computer software product contains the program steps

defense against DoS and DDoS attacks (flood attacks) whereas

each IP SYN (IP connection request) is registered and answered with a SYN ACK for preservation of time restrictions (timeouts) defined in the IP protocol while the registered SYN packet is checked for validity and available services in the target system and

the connection to the target system is initialized and the received data packet is forwarded to the target system for further processing if the verification was successful and the expected ACK as well as a consecutively following valid data packet was received from the requesting external system in the meantime, and/or

link level security whereas the data packets which have to be checked are received directly from the OSI layer 2 (link level), and/or

examination of valid IP headers whereas the structure of each IP packet is checked for validity before it is forwarded to the target system and each invalid packet is rejected, and/or

examination of the IP packet by especially checking the length and the checksum for conformity of the values in the TCP or IP header with the structure of the IP packet and/or

TCP/IP fingerprint protection whereas the answering outgoing data traffic from the secured systems to the requesting external systems is neutralized by using default protocol identifiers, and/or

blocking of each UDP network packet for avoiding attacks at the secured systems via the network protocol UDP (user datagram protocol), by selectively registering and unblocking services required to be reached via UDP whereas for these UDP ports messages are explicitly admitted and the other UDP ports stay closed, and/or

length restrictions of ICMP packets (Internet control message protocol) whereas only ICMP messages with a predefined maximal length are identified as valid data and others are rejected, and/or

exclusion of specific external IP addresses from the communication with the target system, and/or

packet-level firewall function whereas incoming and outgoin IP packets are examined by freely definable rules and because of these rules are rejected or forwarded to the target system, and/or

protection of reachable services of the target system by exclusion of specific services and/or users and/or redirection of service requests to other servers.

A special advantage of the solution relating to the invention is that not only each of the secured systems are protected against DoS and DDoS attacks but also the computer software itself that performs the method of recognition of and defense against attacks on server systems of network service providers and carriers.

The protection against DoS and DDoS attacks makes up the core of the method relating to the invention. The goal of these attacks is to stop the target computer or computers i.e. to crash them by a flood of connection request packets. As a result the attacked systems are no longer able to react to communication requests. By means of an intelligent set of rules each of the secured systems are protected against attempts to attack via DoS and DDoS attacks. Special treatment of the incoming packets is assured by letting only authorized requests pass the secured data line so that the target systems e.g. world-wide-web (WWW) or email servers are not crashed by mass attacks.

An own IP address is not necessary because the packets to be checked are taken directly from the OSI layer 2 in the link level security module. As a result configuration changes of the existing network environment regarding logical addressing (IP routing) are not required. The hardware performing the method is not an addressable network component so neither an aimed attack nor spying out is possible.

Many TCP/IP implementations react incorrectly if the structure of an IP header is invalid. If each IP packet's structure is checked for validity before it is forwarded to the target system, it is assured that only IP packets with correct structure get to the target systems.

For successful attacks on computer systems knowledge of the running operating system is important because aimed attacks base on the knowledge of the operating system of the target computer. TCP/IP fingerprint routines examine the behavior of the TCP/IP implementations of the target system and are able to derive information about the operating system. The invention by its functionality assures that the attacker cannot make conclusions on the operating system by analysis of the returned packets.

There are different methods for attacking computers in a TCP/IP network. One of these methods is the sending of ICMP messages with an inappropriately high packet length. The function for restriction of the ICMP packet length which is integrated into the invention helps to fight this problem.

The possibility to exclude specific external IP addresses increases the total security of the own systems. For example if it is detected that a computer from outside of the network checks which ports of the system are open and thus able to be attacked, it is possible to order that all the packets originating from that computer be rejected. The list of blocked computers (blacklist) can later be modified so that old entries can be deleted again.

Additional to the packet level firewall function on the IP packet layer the invention is extended by security mechanisms relating to the reachable services which are reached via the IP protocols HTTP, FTP, NNTP, POP, IMAP, SMTP, X, LDAP, LPR, Socks or SSL. The exclusion of specific services or users or the redirection of service requests to other servers is assured by this functionality. Easy configuration of this component is enabled by an administration user interface for setting these restrictions.

With the method relating to the invention, the software and the device containing the computer software every incoming and outgoing message is checked. When an attack is detected the solution relating to the invention intervenes specifically and selectively blocks the suspicious data packets without influence on the regular data traffic. All regular data is forwarded with hardly any delay so the operation of the solution relating to the invention causes no disruption of work or communication to the user. This is valid also with high speed (and high data volume) Internet connections (100 Mbit/s) of the server.

Further measures and arrangements of the method relating to the invention result from the sub claims 2 to 6.

With one arrangement of the method relating to the invention the length restriction of ICMP packets the invalid length of packets is reduced to a valid one. Beside the length restriction of ICMP packets specific ICMP message types may be blocked completely.

With another arrangement of the packet-level firewall function the appropriate rules are defined on the basis of special criteria of the IP packet especially referring to exclusions, restrictions and logging. Subsequently the administration software creates a configuration file for the firewall.

With an advantageous arrangement of the invention administrative actions are done only from a console or via secured network connections so that controlled configuration and flawless operation are ensured.

Furthermore the access to the target system may be restricted in detail by adjustable time configurations.

The entirety of this invention consequently is a specially configured hardware, based on PC technology, integrated microchips with additional specially developed microcode. Further, there is a specially developed software, based on the system-link level, which contains a unique interdisciplinary method to react to the miscellaneous problems by different system routines. The invention also assures that the data stream in total for the OSI-layer 3 up to the OSI-layer 7 is already selected on the link-level (OSI-layer 2) and at that level deeply examined against security related contents in all upper layers. An essential feature of the invention is consequently, the proactive extention for the low level data line (which is normally passive) with the active intelligence to detect attack relevant contents in the whole data stream. Because of the objective fact, that the implemented methods of detection are able to detect also “flood-attacks” and other attacks for the “IP-stack” and for various “operating systems”, there are additional unique characteristics implemented. The invention (hard- and software combined) protects itself and all correctly connected systems behind against the various attacks. The combined solution should be installed between the screening router and the normally to that router connected systems. With the implemented different methods, which can be set in as a whole or restricted, because of the modularity of the invention, the various attacks in the whole IP data stream (incl. the Internet protocol itself) will be detected and defended. The data is independent of the IP-header or IP-address directly from the link-level selected and will be checked by a kind of “neutral instance”, which means the invention, for attack related contents. The system where this “neutral instance” is running needs no IP-address. Therefore it can't be attacked on the IP-level, which is also a differentiator of this invention. For all active network components this system is hidden and unreachable.

One essential element of this invention is the active detection of DoS- and DDoS-attacks, which are via this combined hard- and software solution now possible. On the side of server provider implemented, the server systems can be protected against DoS- and DDoS-attacks. On the side of network provider implemented, the lines can be protected against the still possible line flooding. Important: Using this functionality of the invention only, the existing firewalls are not to be replaced, but used as essential extension of the security model.

It goes without saying that the aforementioned and following characteristics are not mutually exclusive but can be utilized in other combinations or on their own. This would not exceed the scope of the present invention.

The basic approach of the invention is shown in the following description with some implementation examples described in the figures. The figures show:

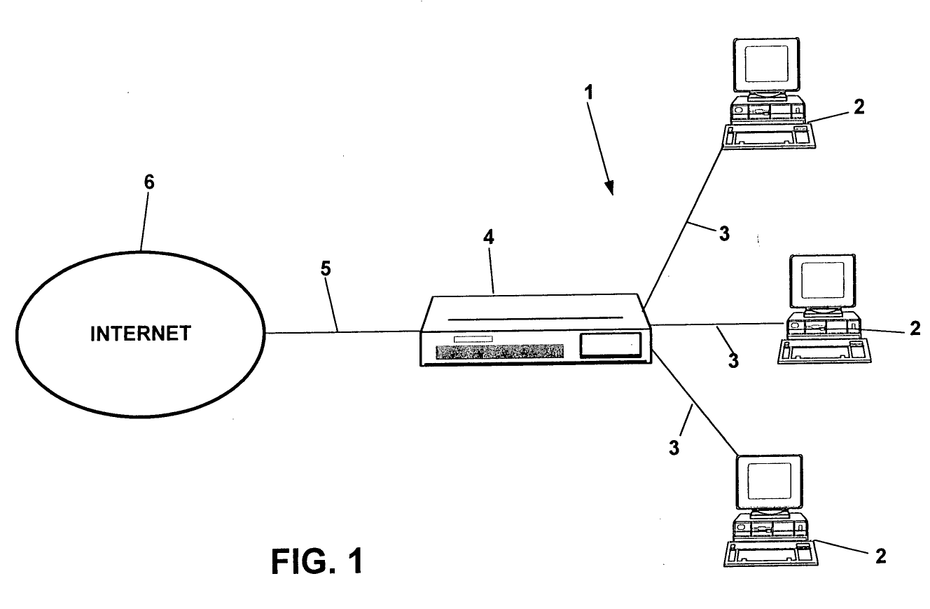

FIG. 1 a schematic description of a computer system corresponding to the invention which is connected to the Internet in a small network environment;

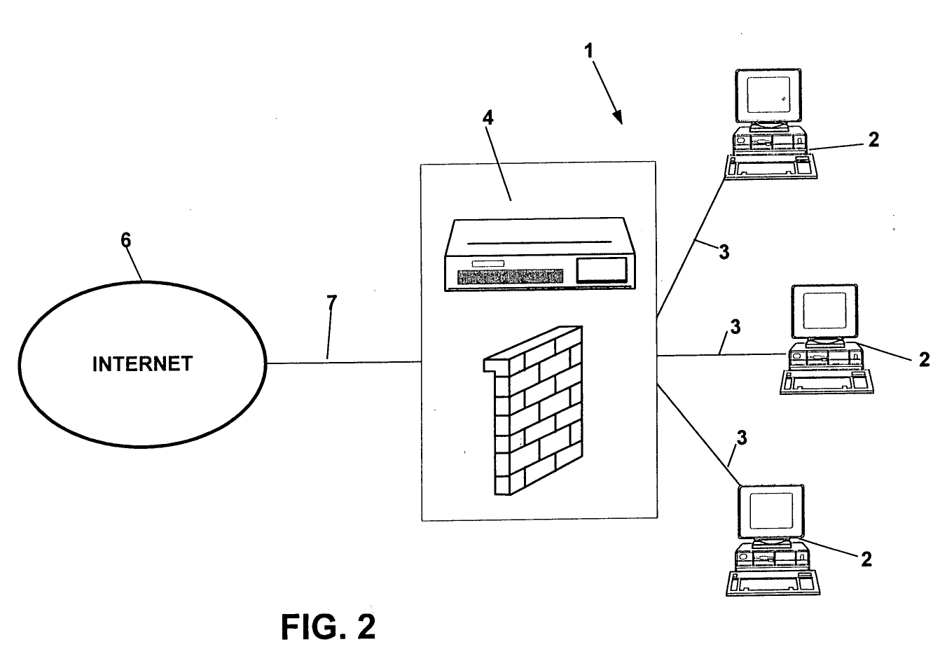

FIG. 2 a schematic description of a computer system corresponding to the invention which is connected to the Internet in a medium-sized network environment;

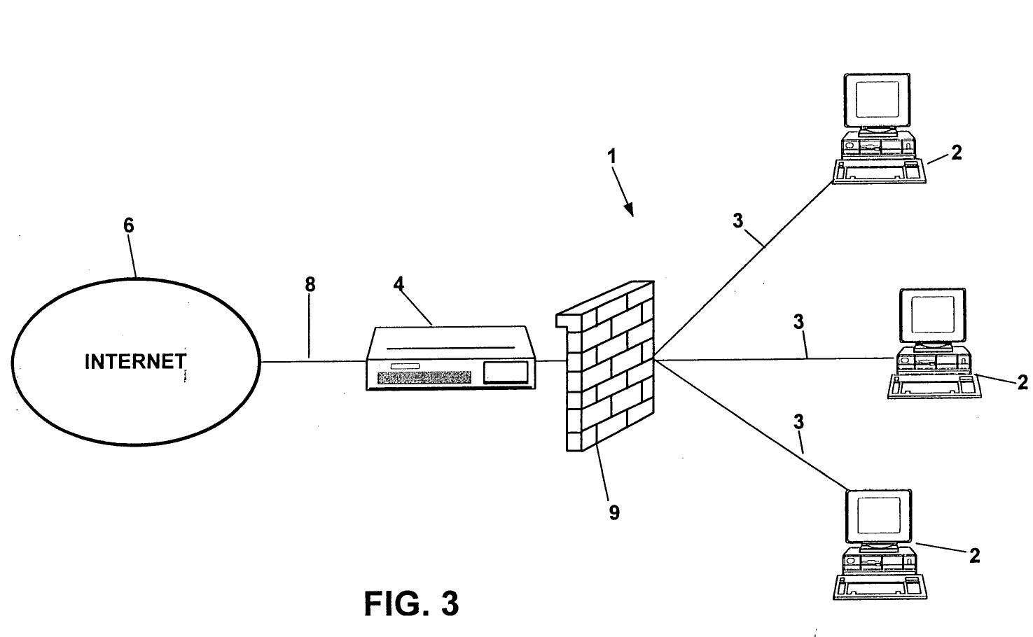

FIG. 3 a schematic description of a computer system corresponding to the invention which is connected to the Internet in a large network environment;

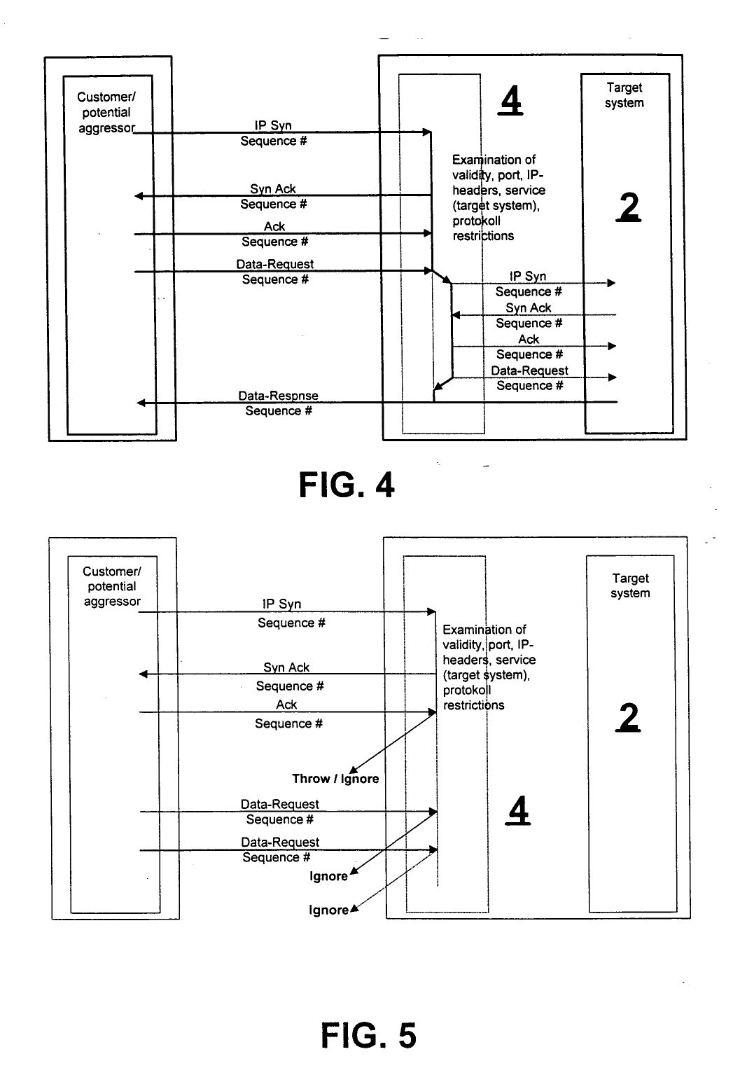

FIG. 4 a schematic description of a procedure corresponding to the invention establishing a connection with the authorized use of a protocol;

FIG. 5 a schematic description of a procedure corresponding to the invention building up a connection with the non-authorized use of a protocol;

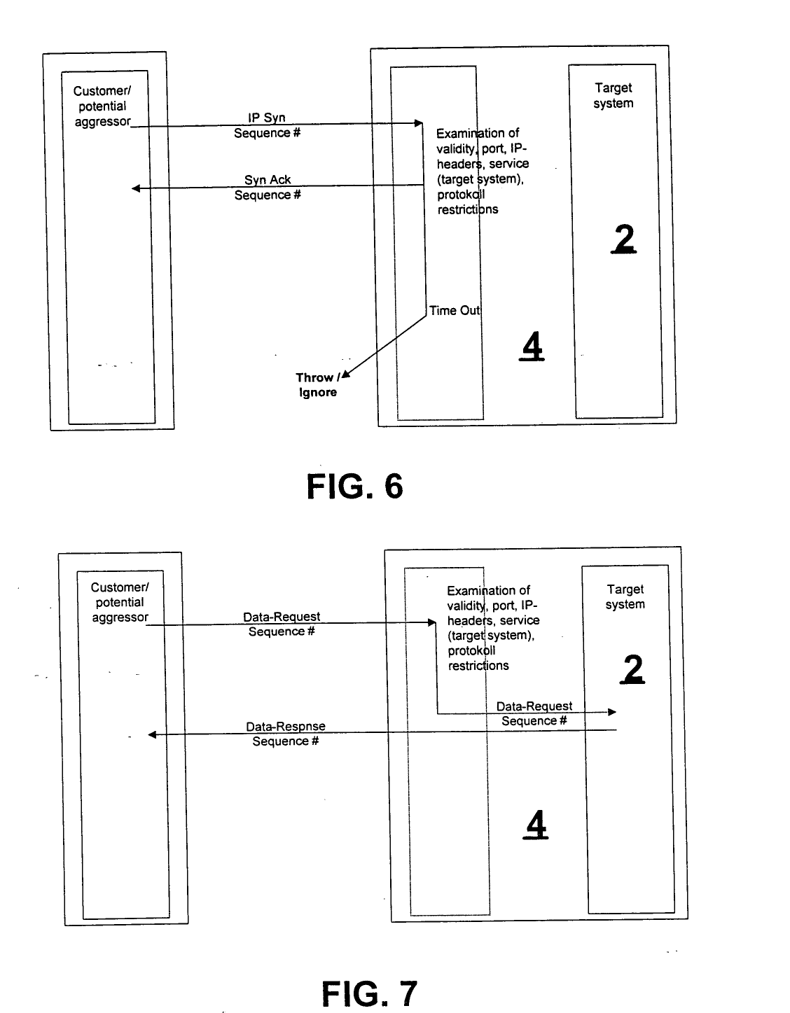

FIG. 6 a schematic description of a procedure corresponding to the invention failing to establish a connection;

FIG. 7 a schematic description of a procedure corresponding to the invention after establishing a connection with authorized flow of data;

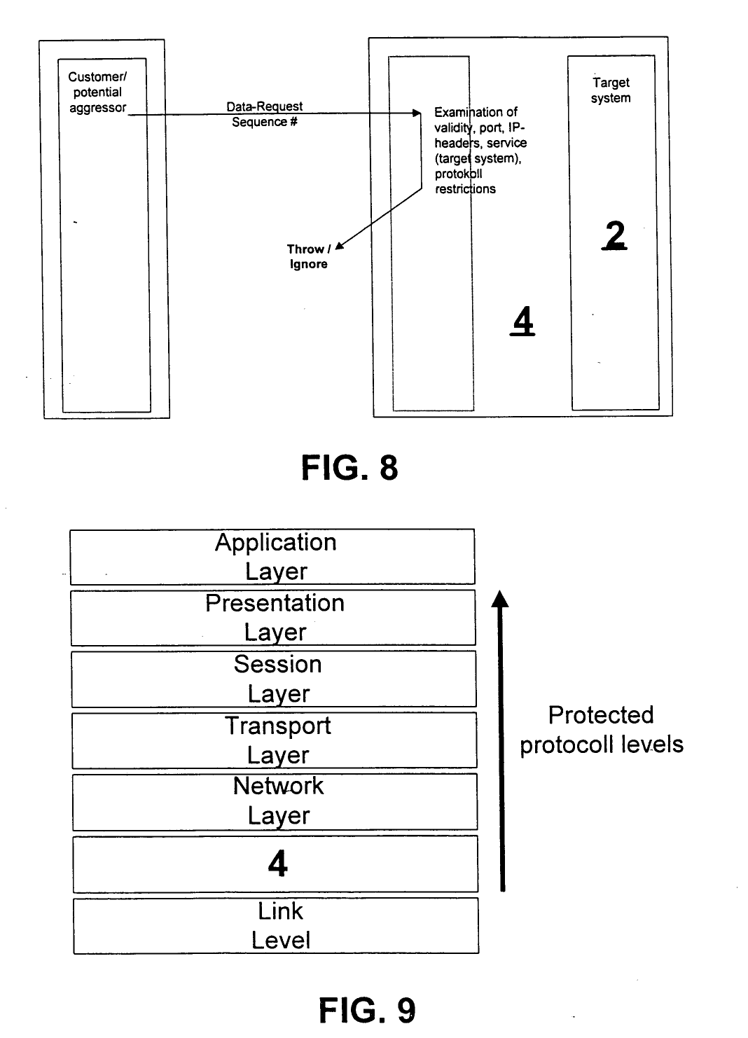

FIG. 8 a schematic description of a procedure corresponding to the invention after establishing a connection with non-authorized flow of data;

FIG. 9 a schematic description of the protocol levels protected through an electronic device;

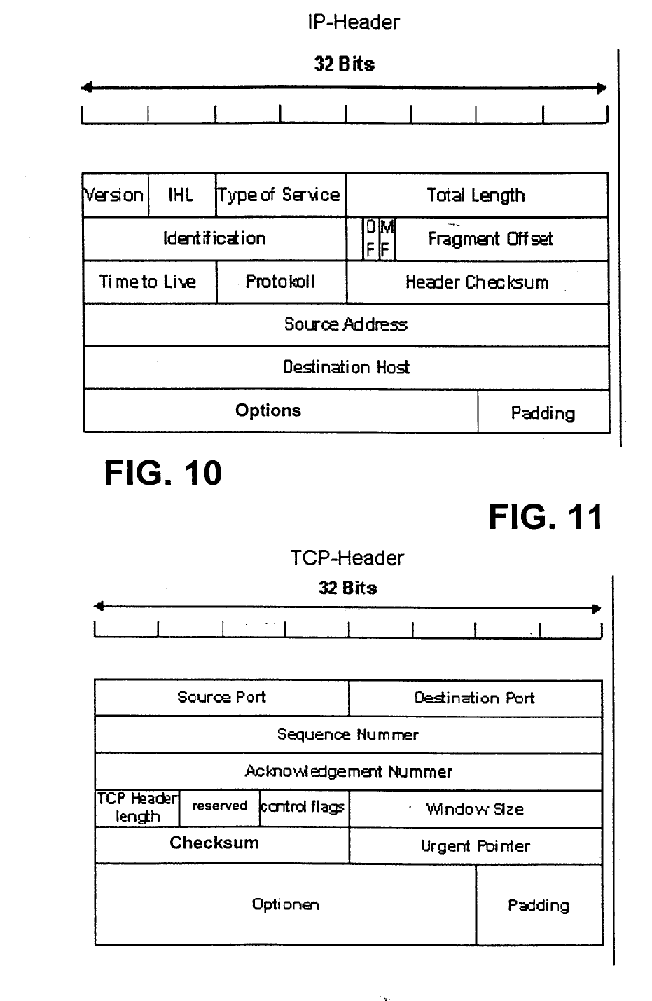

FIG. 10 a description of the examination of valid IP headers;

FIG. 11 a description of the examination of an IP packet;

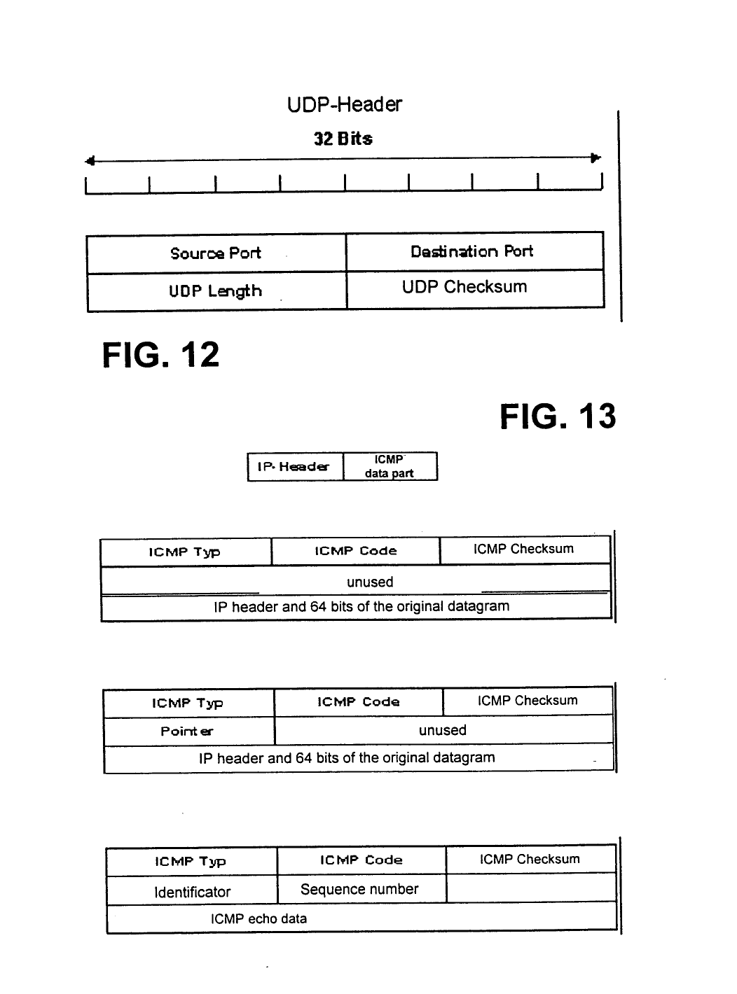

FIG. 12 a description of the examination of adjustable UDP connections and

FIG. 13 a description of the length limitations of ICMP packets.

The computer system 1 according to FIGS. 1 to 3 consists of several server computers 2 which are possibly mutually connected through further data lines. Those are not described in further details. The server computers are connected to an electronic device 4 via a data line 3 each. This device shows a data carrier instructed as EPROM, which is not described in further details, which implements a computer program to recognize and to refuse the attacks on server systems of network providers and operators.

The electronic device 4 is connected to the Internet via an ISDN data line 5 according to FIG. 1. The electronic device serves as protection of DOS and DDOS attacks and as an enhanced functionality as Internet gateway via ISDN. In addition to this, the electronic device 4 is equipped with an Ethernet and an ISDN adapter. Beside the protection of the systems in the Local Area Network (LAN) against DOS and DDOS attacks, the electronic device 4 is used as router for the access on services of the Internet. The establishing of the ISDN connection is, as a standard, effected whenever a communication access to an external network is requested. The establishing of a connection is effected automatically if the computer program contained in the EPROM within the electronic device 4 does not transfer any further network packets after a certain time frame. One can modify this standard attribute through a corresponding configuration.

The electronic device 4 is, for instance, connected to the Internet 6 via an ISDN/Ethernet data line 7 according to FIG. 2. In addition to this, the electronic device 4 integrates a non-visible firewall-function-module. Thus it can be used as integrated firewall router, possibly via a further dedicated router. The server computers 2 or personal computers, respectively of the internal network use the electronic device 4 with the EPROM including the computer program protecting and refusing attacks on servers systems of network service providers and operators as transition into the Internet via Ethernet or ISDN. Moreover, the electronic device 4 protects the internal systems against DOS and DDOS attacks. With this incoming and outgoing IP packets are forwarded or aborted by means of defined rules. The access to the services open to the public is approved or denied according to defined rules on the locals systems.

The rules necessary for the individual functions are established and modified through a configuration program being able to establish a readable configuration set according to simplified inputs of users as well. The functions offered by the electronic device 4 including the computer program for recognizing and refusing attacks on server systems of network service providers and operators may be configured freely to a large extent. Thus they can be adopted for the use within the own network in an optimal way.

The way of describing the invention according to FIG. 3 shows the firewall-function-module 9 being separate that is to say switched separately between the server computers 2 and the electronic device 4 including the computer program for recognizing and refusing attacks on server systems of network service providers and operators. The electronic device 4 is connected to the Internet 6 via an Ethernet data line 8 and offers the protection necessary against DOS and DDOS attacks (flood attacks). Only those network packets will be forwarded to the firewall for further handling which do not cause any harm to the target system concerned. After that the decision whether to accept or deny forwarding the network packets is taken on the firewall.

FIG. 4 shows a schematic description of the procedure when establishing a connection with authorized use of protocol whereas FIG. 5 shows the procedure when establishing a connection with non-authorized use of protocol.

FIG. 6 shows the procedure corresponding to the invention with the failing of completely establishing a connection. FIG. 7 schematically simulates the procedure after establishing a connection with authorized flow of data and FIG. 8 simulates the procedure after establishing a connection with non-authorized data flow.

FIG. 9 show a schematic description of the protocol levels being protected through an electronic device with the EPROM including the computer program protecting and refusing attacks on servers systems of network service providers and operators.

FIG. 10 describes the examination of valid IP headers. FIG. 11 describes the examination of an IP packet. FIG. 12 describes the examination of adjustable UDP connections and FIG. 13 describes the length limitations of ICMP packets.

### List of Signs of Reference

1 computer system

2 server computer

3 data line

4 Electronic device

5 ISDN data line

6 Internet

7 ISDN/Ethernet data line

8 Ethernet data line

1. Method for recognizing and refusing attacks on server systems of network providers and operators by means of an electronic device to be implemented in a computer network, this device contains a computer program characterized by the components and the steps of procedures:
defense against DoS and DDoS attacks (flood attacks) whereas
each IP SYN (IP connection request) is registered and answered with a SYN ACK for preservation of time restrictions (timeouts) defined in the IP protocol while the registered SYN packet is checked for validity and available services in the target system and
the connection to the target system is initialized and the received data packet is forwarded to the target system for further processing if the verification was successful and the expected ACK as well as a consecutively following valid data packet was received from the requesting external system in the meantime, and/or
link level security whereas the data packets which have to be checked are received directly from the OSI layer 2 (link level), and/or
examination of valid IP headers whereas the structure of each IP packet is checked for validity before it is forwarded to the target system and each invalid packet is rejected, and/or
examination of the IP packet by especially checking the length and the checksum for conformity of the values in the TCP or IP header with the structure of the IP packet and/or
TCP/IP fingerprint protection whereas the answering outgoing data traffic from the secured systems to the requesting external systems is neutralized by using default protocol identifiers, and/or
blocking of each UDP network packet for avoiding attacks at the secured systems via the network protocol UDP (user datagram protocol), by selectively registering and unblocking services required to be reached via UDP whereas for these UDP ports messages are explicitly admitted and the other UDP ports stay closed, and/or
length restrictions of ICMP packets (Internet control message protocol) whereas only ICMP messages with a predefined maximal length are identified as valid data and others are rejected, and/or
exclusion of specific external IP addresses from the communication with the target system, and/or
packet-level firewall function whereas incoming and outgoing IP packets are examined by freely definable rules and because of these rules are rejected or forwarded to the target system, and/or
protection of reachable services of the target system by exclusion of specific services and/or users and/or redirection of service requests to other servers.

2. Method according to claim 1, characterized by the fact that with the limitation in length of ICMP packets, the invalid length of a ICMP packet is reduced to an approved length.

3. Method according to claim 1, characterized by the fact that with the limitation in length of ICMP packets, single ICMP types of message are entirely blocked.

4. Method according to claim 1, characterized by the fact that the rules for the packet-level-firewall-function are determined on the basis of certain criteria of a IP packet, especially concerning exclusions, limitations and log editions.

5. Method according to claims 1 to 4, characterized by the fact that in order to achieve a controlled configuration and to guarantee unlimited function of the procedure, administrative operations can only be effected from a console or via secure network connection ways.

6. Method according to claims 1 to 5, characterized by the fact that the access on a target system is limited on time windows which could be set freely.

7. Data carrier containing a computer program for recognizing and refusing attacks on server systems of network service providers and operators for the use of an electronic device to be included in a computer network characterized by the program steps:
defense against DoS and DDoS attacks (flood attacks) whereas
each IP SYN (IP connection request) is registered and answered with a SYN ACK for preservation of time restrictions (timeouts) defined in the IP protocol while the registered SYN packet is checked for validity and available services in the target system and
the connection to the target system is initialized and the received data packet is forwarded to the target system for further processing if the verification was successful and the expected ACK as well as a consecutively following valid data packet was received from the requesting external system in the meantime, and/or
link level security whereas the data packets which have to be checked are received directly from the OSI layer 2 (link level), and/or
examination of valid IP headers whereas the structure of each IP packet is checked for validity before it is forwarded to the target system and each invalid packet is rejected, and/or
examination of the IP packet by especially checking the length and the checksum for conformity of the values in the TCP or IP header with the structure of the IP packet and/or
TCP/IP fingerprint protection whereas the answering outgoing data traffic from the secured systems to the requesting external systems is neutralized by using default protocol identifiers, and/or
blocking of each UDP network packet for avoiding attacks at the secured systems via the network protocol UDP (user datagram protocol), by selectively registering and unblocking services required to be reached via UDP whereas for these UDP ports messages are explicitly admitted and the other UDP ports stay closed, and/or
length restrictions of ICMP packets (Internet control message protocol) whereas only ICMP messages with a predefined maximal length are identified as valid data and others are rejected, and/or
exclusion of specific external IP addresses from the communication with the target system, and/or
packet-level firewall function whereas incoming and outgoing IP packets are examined by freely definable rules and because of these rules are rejected or forwarded to the target system, and/or
protection of reachable services of the target system by exclusion of specific services and/or users and/or redirection of service requests to other servers.

8. Data carrier according to claim 5, characterized by the fact that this one is instructed as EPROM and as a component of an electronic device.

9. Computer system being connected to network such as Internet (6), Intranet or any similar one, containing one computer or several computers configured as server computer (2) or as client computer, characterized by the fact that a data line to be protected is equipped with an electronic device (4) switched between the network (6) and the server (2) or client computer. This device has got a data carrier with a computer program containing the program steps:
defense against DoS and DDoS attacks (flood attacks) whereas
each IP SYN (IP connection request) is registered and answered with a SYN ACK for preservation of time restrictions (timeouts) defined in the IP protocol while the registered SYN packet is checked for validity and available services in the target system and
the connection to the target system is initialized and the received data packet is forwarded to the target system for further processing if the verification was successful and the expected ACK as well as a consecutively following valid data packet was received from the requesting external system in the meantime, and/or
link level security whereas the data packets which have to be checked are received directly from the OSI layer 2 (link level), and/or
examination of valid IP headers whereas the structure of each IP packet is checked for validity before it is forwarded to the target system and each invalid packet is rejected, and/or
examination of the IP packet by especially checking the length and the checksum for conformity of the values in the TCP or IP header with the structure of the IP packet and/or
TCP/IP fingerprint protection whereas the answering outgoing data traffic from the secured systems to the requesting external systems is neutralized by using default protocol identifiers, and/or
blocking of each UDP network packet for avoiding attacks at the secured systems via the network protocol UDP (user datagram protocol), by selectively registering and unblocking services required to be reached via UDP whereas for these UDP ports messages are explicitly admitted and the other UDP ports stay closed, and/or
length restrictions of ICMP packets (Internet control message protocol) whereas only ICMP messages with a predefined maximal length are identified as valid data and others are rejected, and/or
exclusion of specific external IP addresses from the communication with the target system, and/or
packet-level firewall function whereas incoming and outgoing IP packets are examined by freely definable rules and because of these rules are rejected or forwarded to the target system, and/or
protection of reachable services of the target system by exclusion of specific services and/or users and/or redirection of service requests to other servers.

10. Computer programme product containing computer codes for recognizing and refusing attacks on server systems of network service providers and operators by means of an electronic device to be included in a computer network, characterized by the program steps:
defense against DoS and DDoS attacks (flood attacks) whereas
each IP SYN (IP connection request) is registered and answered with a SYN ACK for preservation of time restrictions (timeouts) defined in the IP protocol while the registered SYN packet is checked for validity and available services in the target system and
the connection to the target system is initialized and the received data packet is forwarded to the target system for further processing if the verification was successful and the expected ACK as well as a consecutively following valid data packet was received from the requesting external system in the meantime, and/or
link level security whereas the data packets which have to be checked are received directly from the OSI layer 2 (link level), and/or
examination of valid IP headers whereas the structure of each IP packet is checked for validity before it is forwarded to the target system and each invalid packet is rejected, and/or
examination of the IP packet by especially checking the length and the checksum for conformity of the values in the TCP or IP header with the structure of the IP packet and/or
TCP/IP fingerprint protection whereas the answering outgoing data traffic from the secured systems to the requesting external systems is neutralized by using default protocol identifiers, and/or
blocking of each UDP network packet for avoiding attacks at the secured systems via the network protocol UDP (user datagram protocol), by selectively registering and unblocking services required to be reached via UDP whereas for these UDP ports messages are explicitly admitted and the other UDP ports stay closed, and/or
length restrictions of ICMP packets (Internet control message protocol) whereas only ICMP messages with a predefined maximal length are identified as valid data and others are rejected, and/or
exclusion of specific external IP addresses from the communication with the target system, and/or
packet-level firewall function whereas incoming and outgoing IP packets are examined by freely definable rules and because of these rules are rejected or forwarded to the target system, and/or
protection of reachable services of the target system by exclusion of specific services and/or users and/or redirection of service requests to other servers.
